(19) United States
(12) Patent Application Publication
(10) Pub. No.: US 2015/0284040 A1
(43) Pub. Date: Oct. 8, 2015

(54) ADJUSTABLE SPARE TIRE CART

(71) Applicants: Donald Wolfgang Dombrowsky, Edmonton (CA); Joanne Clinton, Edmonton (CA)

(72) Inventors: Donald Wolfgang Dombrowsky, Edmonton (CA); Joanne Clinton, Edmonton (CA)

(21) Appl. No.: 14/244,944

(22) Filed: Apr. 4, 2014

(51) Int. Cl. B62D 43/04; B62D 43/00

(52) U.S. Cl. CPC B62D 43/04; B62D 43/002

(57) ABSTRACT

The present invention is directed to a spare tire cart suitable for mounting to the undercarriage of a vehicle. The cart includes upper and lower frames, each having a crossbar, a pair of exterior support rails extending perpendicularly from the crossbar, a pair of interior support rails extending perpendicularly from an interior portion of the crossbar, and a pair of wheels mounted near each end of the crossbar. The cart further includes a handle slidably mounted to the upper frame crossbar and a pair of tire support rollers slidably mounted to the lower frame crossbar and extending perpendicularly therefrom. In addition, the cart includes a yoke receiving plate slidably engaged with the upper frame or lower frame.

### BACKGROUND OF THE INVENTION

1. Technical Field

The present invention relates to an adjustable spare tire cart for use with an undercarriage-stored spare tire assembly.

2. Description of Related Art

In many sport utility vehicles, minivans and pickup trucks, the spare wheel assembly is located on the rear underside of the vehicle. A winch type mechanism mounted to the undercarriage of the vehicle is used to secure the spare wheel against the undercarriage of the vehicle body where it is stored, and to raise and lower the spare tire as necessary.

As many drivers of SUVs, minivans and pickup trucks know, changing the tire of a vehicle having an undercarriage-stored spare tire can be difficult. That is especially so in a roadside setting, where the person changing the tire often has to do so without assistance from another person. Undercarriage-stored spare tires are heavy, and therefore difficult to pull out from under the vehicle for removal and installation. And installation of the wheel requires lifting the wheel to the height of the wheel hub which, given the weight of undercarriage-stored spare tires, is no easy task for a single individual. In short, removing and installing an undercarriage-stored spare tire is often difficult and may expose an individual to the risk of injury. Moreover, the entire process can be even more difficult in bad weather.

U.S. Patent Publication No. US2010/0119342 describes a spare wheel security and carrying device for protecting from theft and assisting in removal and installation of an undercarriage-mounted spare wheel assembly having frame/cradle with protective bars or mesh the spare wheel is resting upon, mounting means for secure engagement with the factory-installed winch mechanism, casters for convenient transportation of the spare wheel assembly, and a fixed or extendable handle. The disclosed device can be used as a stand-alone universal cart for carrying heavy items.

However, the aforementioned cart is not adjustable relative to the size of the spare tire and lacks support bars which may be used as a fulcrum to facilitate installation of the tire.

Thus, there exists a need for a spare tire cart that facilitates removal and installation of an undercarriage stored spare tire by a single user. The present invention substantially fulfills this need.

### SUMMARY OF THE INVENTION

The present invention is directed to a spare tire cart suitable for mounting to the undercarriage of a vehicle, said cart comprising: (a) an upper frame comprising a crossbar, a first exterior support rail extending perpendicularly from one end of said upper frame crossbar, a second exterior support rail extending perpendicularly from the other end of said upper frame crossbar and parallel to said first exterior support rail, a pair of interior support rails extending perpendicularly from an interior portion of said upper frame crossbar and parallel to said first and second exterior support rails, a wheel mounted near each end of said upper frame crossbar, and a handle; (b) a lower frame slidably engaged with said upper frame, said lower frame comprising a crossbar, a first exterior support rail extending perpendicularly from one end of said lower frame crossbar, a second exterior support rail extending perpendicularly from the other end of said lower frame crossbar and parallel to said first exterior support rail, a pair of interior support rails extending perpendicularly from an interior portion of said lower frame crossbar and parallel to said first and second exterior support rails, a wheel mounted near each end of said lower frame crossbar, and a pair of tire support rollers slidably mounted to said lower frame crossbar and extending perpendicularly therefrom; (c) a yoke receiving plate slidably engaged with said upper frame or said lower frame, said yoke receiving plate capable of providing locking engagement with a spare tire assembly yoke of a vehicle; (d) means for securing said lower frame to said upper frame at a fixed position; (e) means for securing each of the tire support rollers to the lower frame crossbar at a fixed position; and (f) means for securing said yoke receiving plate to said upper frame or said lower frame at a fixed position.

### BRIEF DESCRIPTION OF THE DRAWINGS

The invention will be better understood and objects other than those set forth above will become apparent when consideration is given to the following detailed description thereof. Such description makes reference to the annexed drawings wherein:

FIG. 1 is a top view of the spare tire cart of the present invention.

FIG. 2 is a perspective view of the spare tire cart of the present invention showing the relation of the cart to the vehicle winch cable, vehicle spare tire assembly yoke and spare tire.

FIG. 3 is a rear profile view of the spare tire cart of the present invention showing the relation of the spare tire to the cart.

In the following description of the invention similar reference characters refer to similar parts throughout the several views of the drawings.

### DETAILED DESCRIPTION

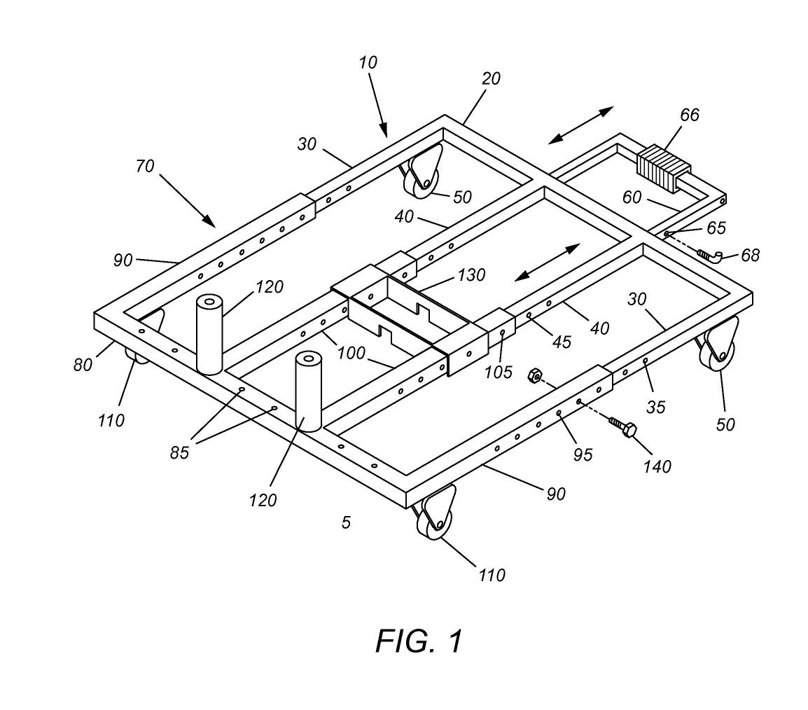

FIG. 1 shows spare tire cart 5 having an upper frame 10 and lower frame 70. Upper frame 10 includes upper frame crossbar 20, upper frame exterior support rails 30, upper frame interior support rails 40, upper frame wheels 50 and handle 60. Upper frame exterior support rails 30 include holes 35, and upper frame interior support rails 40 include holes 45. Lower frame 70 includes lower frame crossbar 80, lower frame exterior support rails 90, lower frame interior support rails 100, lower frame wheels 110 and tire support rollers 120. Handle 60 includes holes 65, lower frame exterior support rails 90 include holes 95, lower frame interior support rails 100 include holes 105 and lower frame crossbar 80 includes holes 85. Spare tire cart 5 also includes yoke receiving plate 130, and handle 60 includes hand grip 66. Cotter pins 140 may be used to secure upper frame 10 to lower frame 70.

In operation, upper frame 10 is slidably engaged with lower frame 70, thereby allowing a user to adjust the size of spare tire cart 5 to accommodate spare tires of differing sizes. Once upper frame 10 and lower frame 70 are in an appropriate position for a particular spare tire, securing means (e.g., cotter pins 140) are used to lock the frames in position. Likewise, tire support rollers 120 are slidably mounted onto lower frame crossbar 80, and therefore can be adjusted to fit spare tires of differing sizes. Once in the desired positions, tire support rollers 120 are secured to lower frame crossbar 80 using holes 85 and appropriate securing means (e.g., bolts, washers and nuts; not shown). Tire support rollers 120 may be rotatable in a counter-clockwise or clock-wise direction, thereby allowing the spare tire, when mounted onto spare tire support rollers 120, to be rotated as necessary to line-up the hole pattern of the spare tire rim with the stud pattern of the vehicle wheel. Yoke receiving plate 130 is slidably engaged with upper frame interior support rails 40 or lower frame interior support rails 100, and therefore can be adjusted to fit spare tires of differing sizes. Once in the desired position, yoke receiving plate 130 is secured to either upper frame interior support rails 40 or lower frame interior support rails 100 using holes 45 or 105 and appropriate securing means (e.g., bolts, washers and nuts; not shown). Yoke receiving plate 130 is capable of providing locking engagement with a spare tire assembly yoke of a vehicle. Finally, handle 60 is slidably engaged with upper frame crossbar 20, thereby permitting handle 60 to be alternately moved between a retracted position (e.g., during storage) and an extended position (e.g., in use). Once in the desired position, handle 60 is secured in position using one or more holes 65 and appropriate securing means (e.g., spring loaded pin 68). Lower frame wheels 100 may include locking means (e.g., caster locking wheels, not shown) to secure wheels 110 in position, thereby stabilizing cart 5 when lifting the spare tire from cart 5 during spare tire installation.

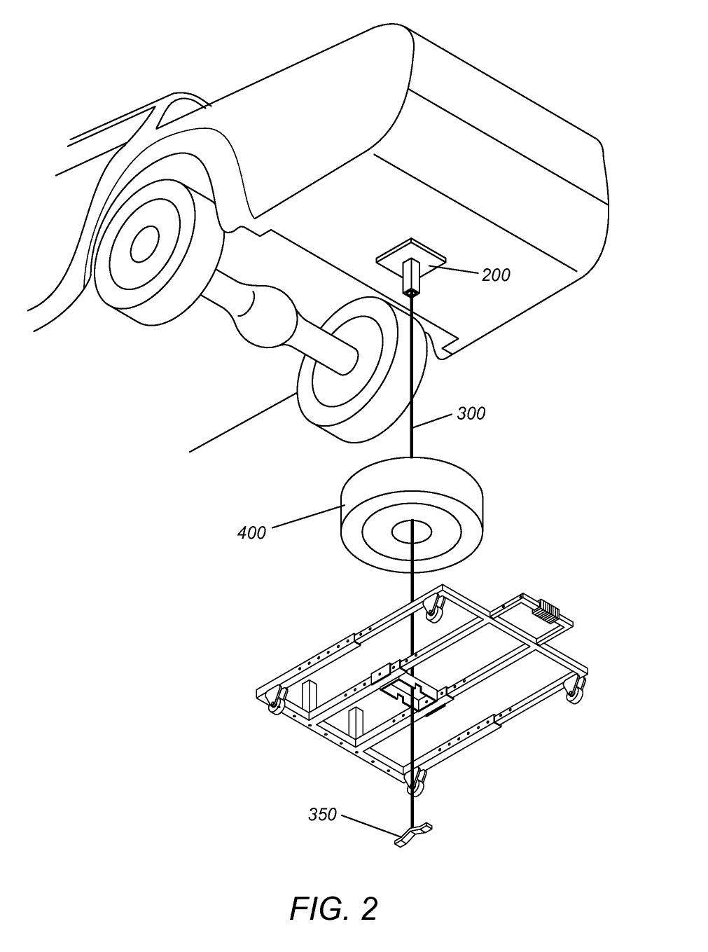

FIG. 2 shows the relation of the cart to the vehicle winch cable, vehicle spare tire assembly yoke and spare tire. Vehicle winch cable 300 extends from vehicle spare tire assembly 200, passes through spare tire 400 and then through yoke receiving plate 130 of cart 5. When vehicle winch cable 300 is retracted, vehicle spare tire assembly yoke 350 engages with yoke receiving plate 130 to secure cart 5 and spare tire 300 in position in the undercarriage of the vehicle. When the spare tire is needed, vehicle winch cable 300 is extended until cart 5 rests on the ground. Vehicle spare tire assembly yoke 350 is then disengaged from yoke receiving plate 130 and retracted, thereby allowing cart 5 carrying spare tire 300 to be easily and safely rolled out from underneath the vehicle. During spare tire installation, tire support rollers 120 may be used as a fulcrum to lift spare tire 300 as needed to place it onto the vehicle wheel assembly.

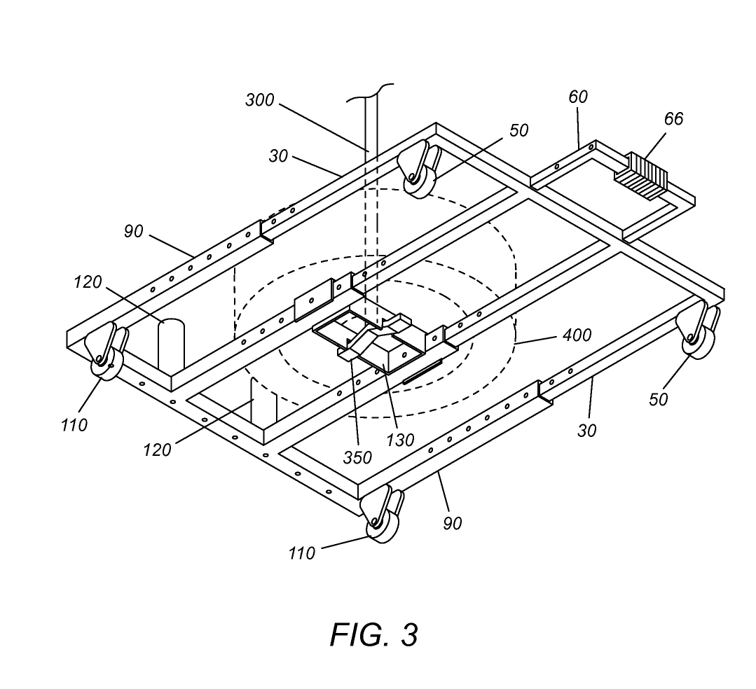

FIG. 3 shows spare tire 400 resting on cart 5 and secured thereto with vehicle winch cable 300 and spare tire assembly yoke 350. Vehicle winch cable 300 passes through spare tire 400 and yoke receiving plate 130 of cart 5, thereby allowing vehicle spare tire assembly yoke 350 to engage with yoke receiving plate 130.

Spare tire cart 5 is adjustable to size to fit various sizes of spare tires. To provide for size adjustment capability, as mentioned above, upper frame 10 is slidably engaged with lower frame 70, tire support rollers 120 are slidably mounted onto lower frame crossbar 80 and yoke receiving plate 130 is slidably engaged with upper frame interior support rails 40 or lower frame interior support rails 100. Securing the various parts in the desired positions may be accomplished with any suitable means known in the art. For example, upper frame 10 may be secured to lower frame 70, and yoke receiving plate 130 may be secured to upper frame interior support rails 40 or lower frame interior support rails 100, by using cotter pins, nuts and bolts, or the like. Likewise, tire support rollers 120 may be secured to lower frame crossbar 80 using nuts and bolts or any other commonly available means for securing weight-supporting bars to a frame.

In addition, handle 60 may be positioned in a retracted position or in one or more extended positions. Since handle 60 should be placed in a retracted position when cart 5 is in use and in the retracted position upon storage, the means for securing handle 60 to upper frame crossbar 20 should allow for easy switching between the retracted and extended positions. Thus, for example, in FIG. 1 a spring-loaded pin serves a means for securing handle 60 to upper frame crossbar 20. Of course, any other such means which is easily toggled between an engaged position and a disengaged position may be used.

The cart of the present invention may be made of any suitable material including, for example, iron, steel, aluminum, carbon graphite and the like.

While particular embodiments of the present invention have been shown and described herein for purposes of illustration, it will be understood that the invention is not limited thereto. Modifications may be made by persons skilled in the art, particularly in light of the foregoing teachings, without deviating from the spirit and scope of the invention. Accordingly, the invention is not limited except as by the appended claims.

All of the U.S. patents and published U.S. patent applications referred to in this specification are incorporated herein by reference in their entirety to the extent not inconsistent with the present description.

What is claimed is:

1. A spare tire cart suitable for mounting to the undercarriage of a vehicle, said cart comprising:
(a) an upper frame comprising a crossbar, a first exterior support rail extending perpendicularly from one end of said upper frame crossbar, a second exterior support rail extending perpendicularly from the other end of said upper frame crossbar and parallel to said first exterior support rail, a pair of interior support rails extending perpendicularly from an interior portion of said upper frame crossbar and parallel to said first and second exterior support rails, a wheel mounted near each end of said upper frame crossbar, and a handle;
(b) a lower frame slidably engaged with said upper frame, said lower frame comprising a crossbar, a first exterior support rail extending perpendicularly from one end of said lower frame crossbar, a second exterior support rail extending perpendicularly from the other end of said lower frame crossbar and parallel to said first exterior support rail, a pair of interior support rails extending perpendicularly from an interior portion of said lower frame crossbar and parallel to said first and second exterior support rails, a wheel mounted near each end of said lower frame crossbar, and a pair of tire support rollers slidably mounted to said lower frame crossbar and extending perpendicularly therefrom;
(c) a yoke receiving plate slidably engaged with said upper frame or said lower frame, said yoke receiving plate capable of providing locking engagement with a spare tire assembly yoke of a vehicle;
(d) means for securing said lower frame to said upper frame at a fixed position;
(e) means for securing each of said tire support rollers to said lower frame crossbar at a fixed position; and
(f) means for securing said yoke receiving plate to said upper frame or said lower frame at a fixed position.

2. A spare tire cart according to claim 1, wherein each of said upper frame support rails is slidably engaged with a corresponding tire support rail of said lower frame.

3. A spare tire cart according to claim 2, wherein each of said upper frame support rails extends within a corresponding tire support rail of said lower frame.

4. A spare tire cart according to claim 2, wherein each of said lower frame support rails extends within a corresponding tire support rail of said upper frame.

5. A spare tire cart according to claim 1, wherein said handle is slidably engaged with said upper frame crossbar, thereby permitting said handle to be alternately moved between a retracted position and an extended position.

6. A spare tire cart according to claim 5, further comprising means for securing said handle to said upper frame crossbar at a fixed retracted or extended position.

7. A spare tire cart according to claim 6, wherein said means for securing said handle to said upper frame crossbar at a fixed retracted or extended position comprises a spring loaded pin.

8. A spare tire cart according to claim 1, wherein said yoke receiving plate is slidably engaged with said upper frame.

9. A spare tire cart according to claim 1, wherein said yoke receiving plate is slidably engaged with said lower frame.

10. A spare tire cart according to claim 1, wherein each of said wheels mounted near each end of said upper frame crossbar is rotatably mounted to said upper frame crossbar.

11. A spare tire cart according to claim 1, wherein each of said wheels mounted near each end of said lower frame crossbar is rotatably mounted to said lower frame crossbar.

12. A spare tire cart according to claim 1, wherein said means for securing said upper frame to said lower frame comprises a pair of cotter pins, wherein each of said pair of cotter pins affixes an upper frame support rail to a corresponding slidably engaged lower frame support rail.

13. A spare tire cart according to claim 12, wherein each of said pair of cotter pins affixes an exterior upper frame support rail to a corresponding slidably engaged exterior lower frame support rail.

14. A spare tire cart according to claim 1, wherein lower frame crossbar comprises a plurality of holes and said means for securing each of said tire support rollers to said lower frame crossbar at a fixed position comprises a bolt and nut combination.

15. A spare tire cart according to claim 1, wherein said handle comprises a hand grip portion adapted to be comfortably gripped by the hand of a user of said cart.
